(19) United States
(12) Patent Application Publication
(10) Pub. No.: US 2005/0202831 A1
(43) Pub. Date: Sep. 15, 2005

(54) Telephone user interface for efficient self-location of mobile phone

(76) Inventor: Isaias Sudit, Delray Beach, FL (US)

Correspondence Address: EDWARDS & ANGELL, LLP, P.O. BOX 55874, BOSTON, MA, 02205, US

(21) Appl. No.: 11/067,817

(22) Filed: Feb. 28, 2005

Related U.S. Application Data
(60) Provisional application No. 60/553,240, filed on Mar. 15, 2004.

(51) Int. Cl. G01C 21/26

(52) U.S. Cl. 455/456.1

(57) ABSTRACT

Method for identifying a location of a wireless device responsive to a single user command. The method can include (a) determining a physical location of the wireless device using at least one of a global positioning system and a network based solution, (b) communicating data identifying the physical location to a remote location application server, (c) building a map file at the location application server based at least in part on the data, (d) notifying the wireless device that the map file is available, (e) retrieving physical location data and the map file to the wireless device, and (f) showing the location information and displaying a map corresponding to the map file.

### CROSS-REFERENCE TO RELATED APPLICATIONS

This Application is a Non-Provisional of Provisional (35 USC 119(e)) application 60/553,240 filed on Mar. 15, 2004.

### BACKGROUND OF THE INVENTION

The inventive arrangements relate generally to wireless devices and more particularly to wireless devices equipped with automatic location identification capabilities.

In June 1996, the Federal Communications Commission (FCC) set in place a two-phase plan for implementing wireless 911 in the United States. Phase I, which was originally to have been implemented by April 1998, required call-back numbers and cell site sector information about each incoming wireless 911 call. Cell phones that met the Phase I requirements provided a general indication of the caller's location, although the area may be as large as 100 square miles.

Phase II, which was originally scheduled to have been implemented by October 2001, required wireless carriers to provide automatic location identification (ALI) for each wireless 911 call. The plan included a requirement to provide wireless location accuracy for 95% of the callers within a radius of 150 meters or better. The Phase II portion of the plan was intended to enable improved emergency response in connection with 911 calls. The ALI technology necessary to implement Phase II has been delayed in many instances, but is now being deployed in various locations with the expected improvement in emergency response.

There are two basic methods by which wireless position information can be determined. One approach determines a cell phone position by measuring angle of arrival (AOA) and time of arrival (TOA) of cell phone signals at multiple fixed base stations. This approach is essentially a network based solution. Still, there are a number of problems associated with such network based solutions. These problems are mainly related to the vagaries of signal propagation, base station availability and infrastructure costs. An alternative approach makes use of the existing global positioning system (GPS) infrastructure. The GPS based approach incorporates a GPS system into each cell phone and relies upon the phone to determine its location for itself. GPS based systems have their own set of problems that mainly relate to GPS satellite acquisition and cold start delays.

The most advanced ALI systems are those that rely on a combination of both the network based and GPS based solutions. Such systems collect GPS measurements and network measurements and send the measurement data to the position determination entity. The position determination entity then processes the measurements to produce the most accurate location information based on available data.

Currently, ALI technology is commercially available from a number of different technology developers. For example, Qualcomm, Inc. of San Diego, Calif., and SnapTrack, Inc. of Campbell, Calif., offer commercially proven GPS-based positioning solutions for third generation wireless (3G). These systems are available for a variety of different air interfaces including CDMA and GSM. Further, they offer commercially available chipsets that can be integrated in cell phones. Also, rather than requiring modification of each base station, a database is constructed at a position determination entity that contains the precise location of each base station.

Aside from the obvious benefits ALI offers with regard to improving emergency responsiveness, the new technology has also created many opportunities for new and interesting applications that make use of the ALI data. These applications offer revenue-generating products and services that are of potential interest to a range of markets including entertainment, fleet management, and security.

### BRIEF SUMMARY OF THE INVENTION

The invention concerns a method for identifying a location of a wireless device responsive to a single user command. The method can include (a) determining a physical location of the wireless device using a global positioning system, a network based solution, or a combination of the two, (b) communicating data identifying the physical location to a remote location application server, (c) building a map file at the location application server based at least in part on the data, (d) notifying the wireless device that the map file is available, (e) retrieving physical location data and the map file to the wireless device, and (f) showing the location information and displaying a map corresponding to the map file.

The invention can also include a system for identifying a location of a wireless device responsive to a single user command. The system can include (a) a processor programmed for determining a physical location of the wireless device using a global positioning system, a network based solution, or a combination of the two, (b) a communications network communicating data identifying the physical location to a remote location application server, (c) a processor with suitable programming for building a map file at the location application server based at least in part on the data, (d) communications facilities for notifying the wireless device that the map file is available, (e) communication facilities for retrieving physical location data and the map file to the wireless device, and (f) a display for showing the location information and displaying a map corresponding to the map file.

### BRIEF DESCRIPTION OF THE DRAWINGS

FIG. 1 is a drawing that is useful for understanding the operation of a wireless automatic location identification (ALI) system in accordance with the inventive arrangements;

FIG. 2 is a flow chart that is useful for understanding the inventive arrangements;

FIG. 3 is a diagram showing a first screen displayed on a wireless device that is useful for understanding the invention;

FIG. 4 is a diagram showing a second screen displayed on a wireless device that is useful for understanding the invention;

FIG. 5 is a diagram showing a third screen displayed on a wireless device that is useful for understanding the invention;

### DETAILED DESCRIPTION OF THE INVENTION

In many instances, it can be useful for an individual possessing a wireless device to know his own location. However, there are a number of steps involved in obtaining such data. Further, the information associated with the ALI data is coordinate data that is not very useful to most users in numerical format. The invention is intended to solve these and other problems with existing ALI systems.

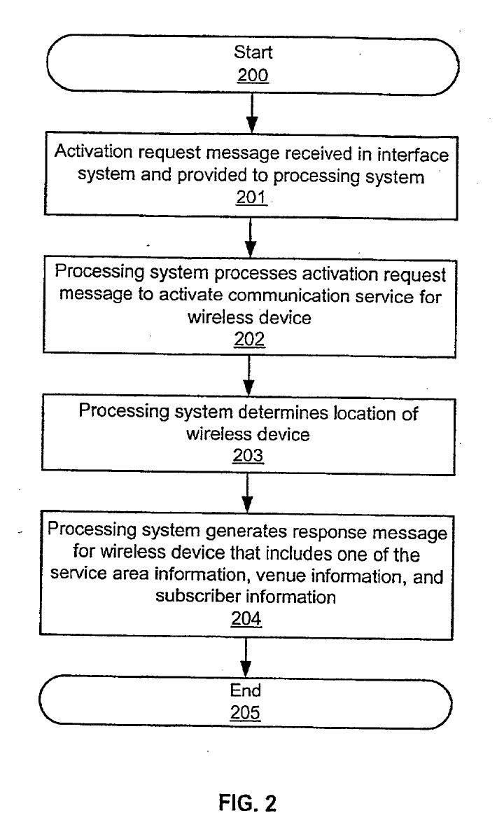

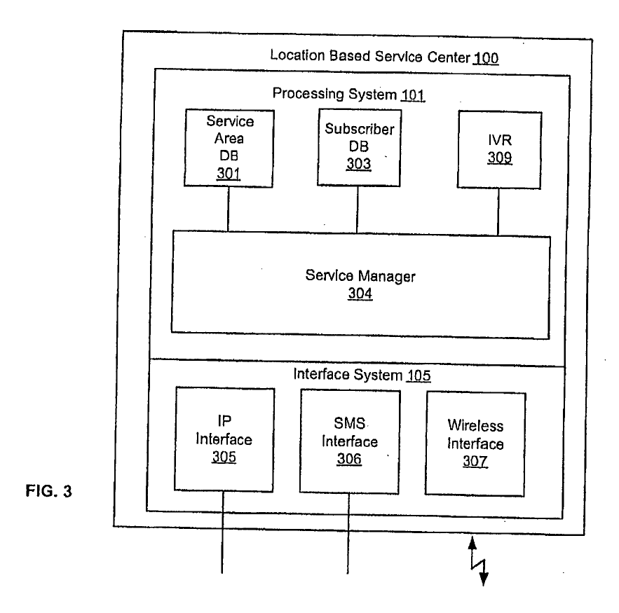

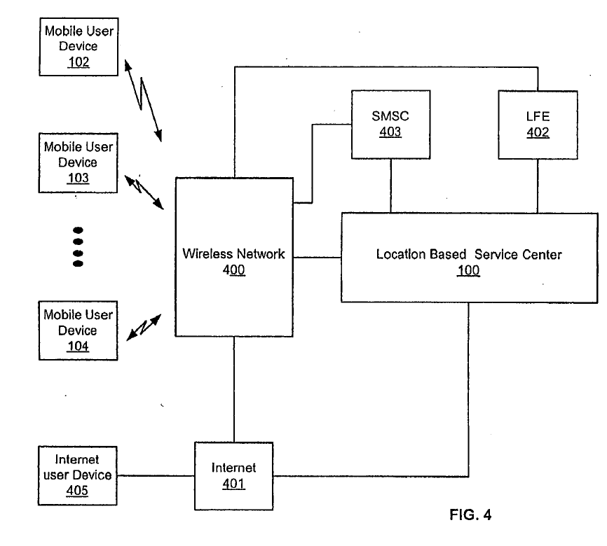

FIG. 2 is a flowchart that is useful for understanding how consumer friendly physical location information can be conveniently provided to users of wireless devices that have ALI capabilities. The process in FIG. 2 can begin in step 202 when a user selects a “find me” option on a wireless device. This step is illustrated in FIG. 3, which shows a wireless device 300 that has a display 301 and a keypad 306 for entering data. A series of icons 304, 308 are presented on the display 301 to identify user options. The display 301 can be a touch screen display, thereby permitting direct activation of associated service by touching each icon on screen. Alternatively, each icon can be identified with a number identifying a corresponding key number corresponding to a key on keypad 306. Pressing the corresponding key can activate the service identified by the associated icon. In either case, the process begins in step 202 by a single key stroke or a single touching of touch screen display to activate the “find me” option. In FIG. 3, the icon 304 represents the “find me” option and the corresponding key for icon 304 is key number 3, identified here with reference number 310. Thus, in step 202, the user selects the “find me” option by pressing key number 3. Alternatively, in the case of a touch screen display, the user could tap on the icon 304.

In FIG. 3, the “find me” option has already been activated as indicated by command line 302. Once the “find me” option is selected by a single user keystroke, a series of additional steps are all performed automatically as illustrated by the flowchart in FIG. 2.

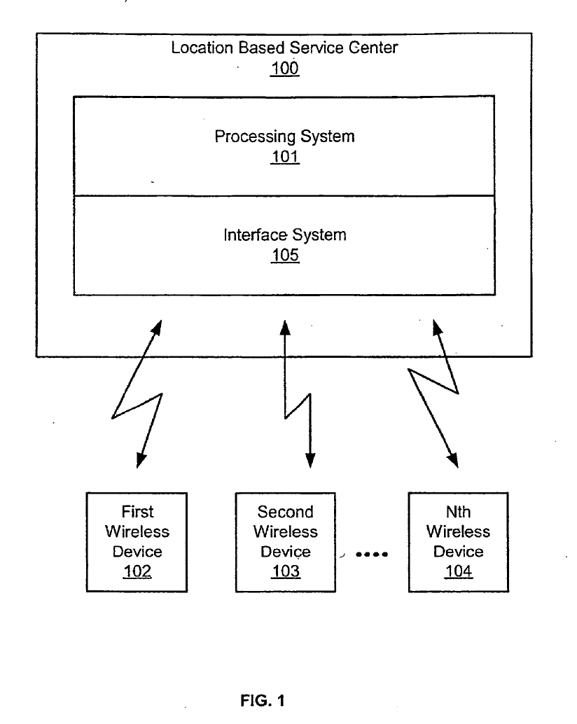

In step 204, the location of the wireless device is automatically calculated. This step can be performed using conventional GPS or network based techniques or a combination of the two (depending on how accurate determination is provided or needed) as described above relative to FIG. 1. Thereafter, in step 206, the location data is communicated by server 108, or wireless device 102, to the “find me” service application server 112. The application server 112 can include at least one user interface 114 for configuring the server and monitoring its operation.

Server 108 stores a coordinate map database such as those provided by NAVTEQ or MAPQUEST by way of non-limiting example. In step 208, the application server can build a map file based at least in part on the location data communicated from server 108 and the map database by comparing the determined position with the map database coordinate. Once this task is complete, the application server 112, can in step 210, notify the wireless device 102 that the map file is available. The notification can be communicated to the wireless device through any one of the base stations 106-1, 106-n.

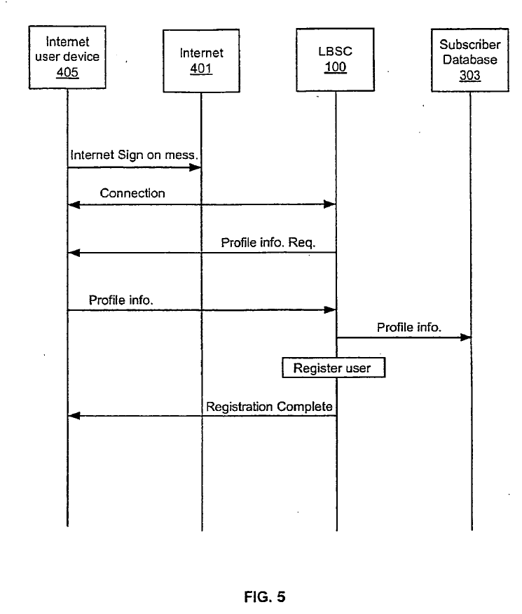

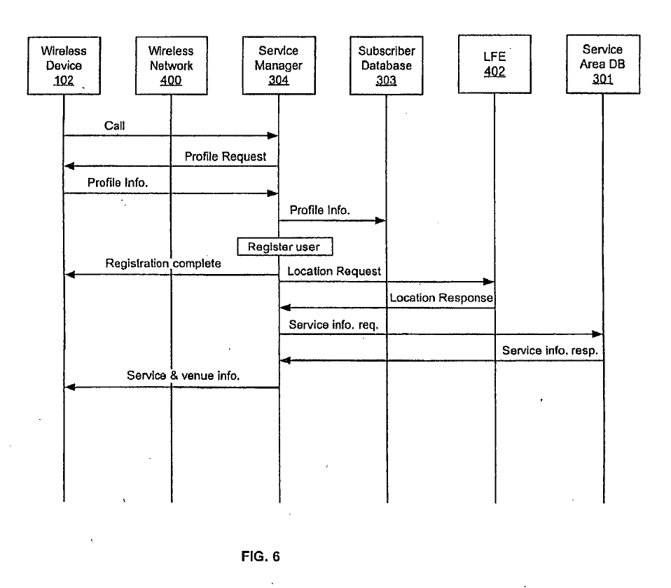

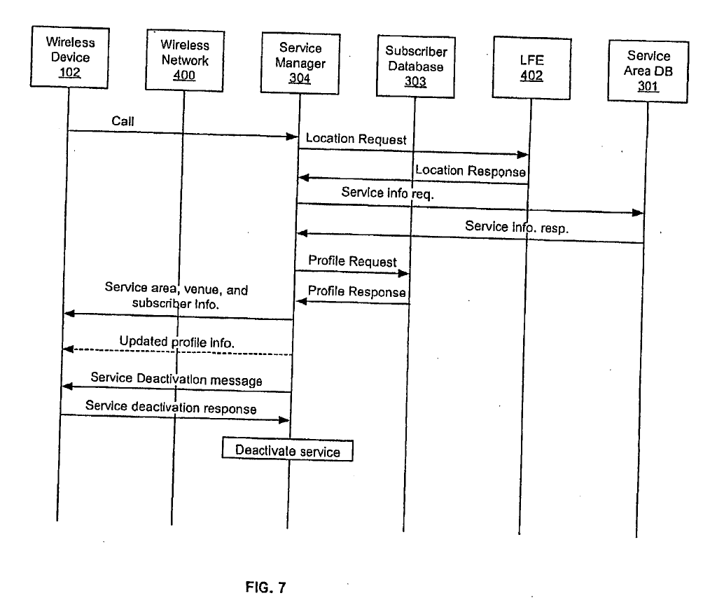

In step 212, the wireless device 102 can retrieve the physical location data and the map file to the wireless device through any of the base stations 106-1, 106-n. During the period when the location of the wireless device is being calculated and the map file is being created, the wireless device 300 can display a suitable message to the user as illustrated in FIG. 4. For example the display 301 can indicate that the user is to wait while the requested information is being assembled. Finally, in step 214, the map file can be automatically displayed as shown in FIG. 5. Using the map file, the display 301 can show various man-made and natural features. For example, the map file can include graphical representations of roads, selected buildings, and bodies of water capable of being displayed on a cell phone with the user location superimposed thereon. The map file can also include a marking 312 to indicate the location of the wireless device relative to such man-made and natural features.

Notably, once the physical location data and the map file have bee received by the wireless device, it can be forwarded to other devices. Thus, a user can select a forward command that will cause the map file and or the physical location data to be forwarded to another device which may or may not have ALI capability. The data can be sent to other devices in the form of a conventional email or by using short message service (SMS) as is known in the art. Further, instant messaging services are becoming more widely available and will soon be implemented in wireless networks such as the one shown in FIG. 1. The physical location data can also be forwarded to third parties using such instant messaging.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims. For example, instead of the geographical calculation concerning location, distance between location, bearing, and/or map generation being performed at the remote server, one or more of such calculations can be performed directly at the wireless device.

1. A method for operating a wireless device comprising the steps of:
responsive to a single user command,
(a) determining a physical location of said wireless device using at least one of a global positioning system and a network based solution,
(b) communicating data identifying said physical location to a remote location application server,
(c) building a map file at said location application server based at least in part on said data,
(d) retrieving physical location data and said map file to said wireless device, and
(e) showing said location information and displaying a map corresponding to said map file.

2. The method of claim 1, further comprising the step of storing a coordinate map database at said remote location application server and comparing the physical location of said wireless device to the map database coordinates.

3. The method of claim 1, further comprising the step of notifying said wireless device that said map file is available.

4. The method of claim 1, further comprising the step of transmitting said physical location data to at least a second wireless device.

5. The method of claim 1, wherein said wireless device is a cellular phone.

6. A system for locating a cellular phone comprising:
a cellular phone;
a remote location application server; and
an Automatic Location Identification Network, said automatic location identification network determining a physical location of said cellular phone, communicating said physical location to said remote location application server, said remote location application server building a map file based at least in part on said physical location of said cellular phone, and transmitting said physical location data and map file to said cellular phone, said cellular phone displaying said location information and a map corresponding to said map file.

7. The system of claim 1, wherein said server stores a coordinate map database, and compares said coordinate map database to said physical location of said cellular phone to build said map file.
